(19) United States
(12) Patent Application Publication
(10) Pub. No.: US 2017/0351193 A1
(43) Pub. Date: Dec. 7, 2017

(54) OPTICAL PRINT HEAD, IMAGE FORMING APPARATUS AND LIGHT AMOUNT CORRECTION METHOD OF OPTICAL PRINT HEAD

(71) Applicants: KABUSHIKI KAISHA TOSHIBA, Tokyo (JP); TOSHIBA TEC KABUSHIKI KAISHA, Tokyo (JP)

(72) Inventors: Hiroyuki Ishikawa, Mishima (JP); Koji Tanimoto, Tagata (JP)

(21) Appl. No.: 15/171,028

(22) Filed: Jun. 2, 2016

(51) Int. Cl. G03G 15/043

(52) U.S. Cl. CPC G03G 15/043

(57) ABSTRACT

An optical print head comprises a first light emitting element row which includes first light emitting elements arranged in a row in a first direction; a second light emitting element row which includes second light emitting elements arranged in a row in the first direction a first drive circuit which drives each first light emitting element with identical first current value and drives each first light emitting element at a light emitting time corresponding to each target gradation value; and a second drive circuit, in response to transmittance of a light passing position of the rod lens array, which drives each second light emitting element with identical second current value and drives each second light emitting element at a light emitting time corresponding to each target gradation value, wherein the second current value is different from the first current value.

### FIELD

Embodiments described herein relate generally to a technology for suppressing dispersion of light from an optical print head.

### BACKGROUND

Conventionally, there is an optical print head in which two rows of light emitting elements are arranged in parallel below a rod lens array in which two rows of rod lenses arranged in parallel are integrated. The two rows of the light emitting elements are positioned alternately in an extending direction of the light emitting element rows.

In the optical print head, there is a case in which undesirable dispersion of light of each light emitted through the rod lens array by each light emitting element occurs. As the main reason of the dispersion, there is dispersion of luminous efficiency of each light emitting element and dispersion of a drive circuit connected with each light emitting element. As the main reason of the dispersion, there is dispersion of the refractive index distribution of the rod lens array and dispersion of a positional relation of each light emitting element with respect to each of the rod lens.

In a case of incorporating the optical print head in an image forming apparatus, the light emitted by each light emitting element forms a beam spot corresponding to one dot on a photoconductor. If there is dispersion of light of each light emitting element, density unevenness of an image occurs and the image quality is degraded. Thus, at the time of shipping the optical print head or at the time of shipping the image forming apparatus incorporated with the optical print head, a light amount correction operation for reducing the dispersion of the light is executed in manufacturing lines.

The amount of light dispersed by the light emitting element depends on an applied current value and light emitting time. In light amount correction, first, currents with the same value are applied to each light emitting element, and the light amount of each light emitting element (light amount of each light emitted through the rod lens array by each light emitting element) is measured. Next, under the condition of the application of the currents with the same value, the light emitting time of each light emitting element is adjusted with a PWM (Pulse Width Modulation) control so that the amounts of the light of the light emitting elements become identical. Correction information serving as an adjustment amount of the light emitting time of each light emitting element is information unique to the optical print head.

In the light amount correction, next, the correction information is written into a built-in memory of the optical print head. Through reading the correction information from the optical print head, the dispersion of the light of each light emitting element can be suppressed.

Incidentally, if the incorporation position of the light emitting element rows and the rod lens array deviates from an ideal position, a difference occurs in light transmittance. Thus, there is a case in which the amounts of light from the light emitting element rows are greatly different. If the amounts of light from the light emitting element rows are greatly different, there is a problem that the dispersion of the light cannot be completely suppressed through the light amount correction according to the light emitting time.

### DESCRIPTION OF THE DRAWINGS

FIG. 1 is a block diagram illustrating control components of an image forming apparatus;

FIG. 2 is a diagram illustrating the structure of a printer section;

FIG. 3 is a perspective view illustrating the structure of an optical print head;

FIG. 4 is a cross-sectional diagram illustrating the optical print head;

FIG. 5 is a block diagram illustrating components of an external device;

FIG. 6 is a flowchart illustrating a light amount correction method;

FIG. 7 is a diagram illustrating a positional relation between light emitting element rows and rod lenses; and

FIG. 8 is a diagram illustrating a measurement result of amounts of light of light emitting elements.

### DETAILED DESCRIPTION

Generally, in accordance with an embodiment, an optical print head comprises a first light emitting element row, a second light emitting element row, a rod lens array, a first drive circuit and a second drive circuit. The first light emitting element row refers to the arrangement of first light emitting elements in a row in a first direction. The second light emitting element row refers to the arrangement of second light emitting elements in a row in the first direction and is positioned at one side of a second direction orthogonal to the first direction with respect to the first light emitting element row. Light emitted by the first light emitting element and the second light emitting element passes through the rod lens array. The first drive circuit drives each first light emitting element with identical first current value and drives each first light emitting element at a light emitting time corresponding to each target gradation value respectively. The second drive circuit, in response to transmittance of a light passing position of the rod lens array, drives each second light emitting element with identical second current value and drives each second light emitting element at a light emitting time corresponding to each target gradation value. The second current value is typically different from the first current value.

Generally, in accordance with the present embodiment, an image forming apparatus comprises a photoconductor, an optical print head and a developing device. The optical print head refers to the foregoing optical print head which forms an electrostatic latent image on the photoconductor. The developing device develops the electrostatic latent image to form a toner image on the photoconductor.

Generally, in accordance with the present embodiment, a light amount correction method is a light amount correction method of an optical print head which comprises first light emitting elements arranged in a row in the first direction, second light emitting elements arranged in a row in the first direction and positioned in the second direction orthogonal to the first direction with respect to the first light emitting element and a rod lens array. The light amount correction method can include a first step, a second step and a third step. The first step refers to driving the first light emitting element with a first current value at first light emitting time and measuring a first light amount of the light emitted by the first light emitting element through the rod lens array. The second step refers to driving the second light emitting element with the first current value at the first light emitting time and measuring a second light amount of the light emitted by the second light emitting element through the rod lens array. The third step refers to driving the first light emitting element with the second current value different from the first current value at the first light emitting time and measuring a third light amount of the light emitted by the first light emitting element through the rod lens array to calculate the second current value of the current through which the light amount of the first light emitting element becomes the second light amount when the first light emitting element is driven at the first light emitting time, or driving the second light emitting element with a third current value different from the first current value at the first light emitting time and measuring a fourth light amount of the light emitted by the second light emitting element through the rod lens array to calculate a fourth current value of the current through which the light amount of the second light emitting element becomes the first light amount when the second light emitting element is driven at the first light emitting time.

Hereinafter, embodiments are described with reference to the accompanying drawings.

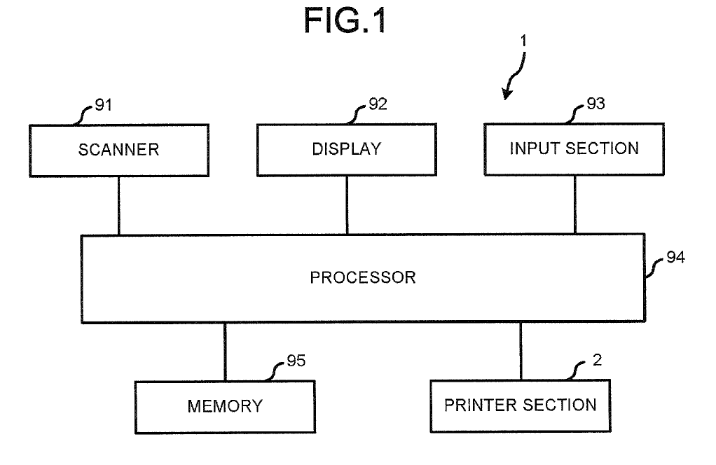

FIG. 1 is a block diagram illustrating control components of an image forming apparatus 1.

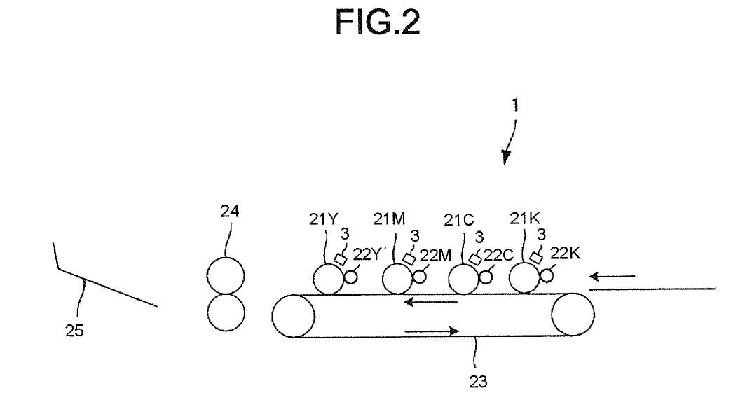

In the image forming apparatus 1, a processor 94, which is a CPU (Central Processing Unit), executes programs stored in a memory 95 to execute various processing of the image forming apparatus 1. A display 92 displays setting information or operation status of the image forming apparatus 1, log information and notification to a user. An input section 93 including a touch panel or buttons receives input of the user. The processor 94 first reads an image of a document with a scanner 91 in a copy processing. FIG. 2 is a diagram illustrating the structure of a printer section 2.

The processor 94 forms electrostatic latent images based on image data on photoconductive drums 21Y-21K with an optical print head 3. The 21Y-21K refers to 21Y, 21M, 21C and 21K. Y is yellow, M is magenta, C is cyan, and K is black. The other reference signs are the same as described above.

The processor 94 develops the electrostatic latent images on the photoconductive drums 21Y-21K with developing devices 22Y-22K through Y-K toners. Y-K toner images are formed on the photoconductive drums 21Y-21K.

The processor 94 transfers Y-K toner images on the photoconductive drums 21Y-21K onto a sheet in the order of Y, M, C and K in an overlapped manner while conveying the sheet with a belt 23. One color image is formed on the sheet.

The processor 94 heats the sheet with a fixing device 24 and discharges the sheet to a tray 25 after the image is fixed on the sheet.

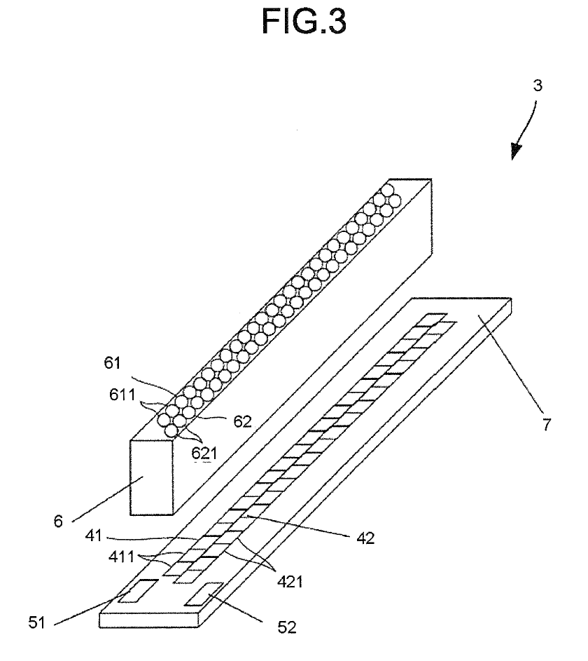

FIG. 3 is a perspective view illustrating the structure of the optical print head 3.

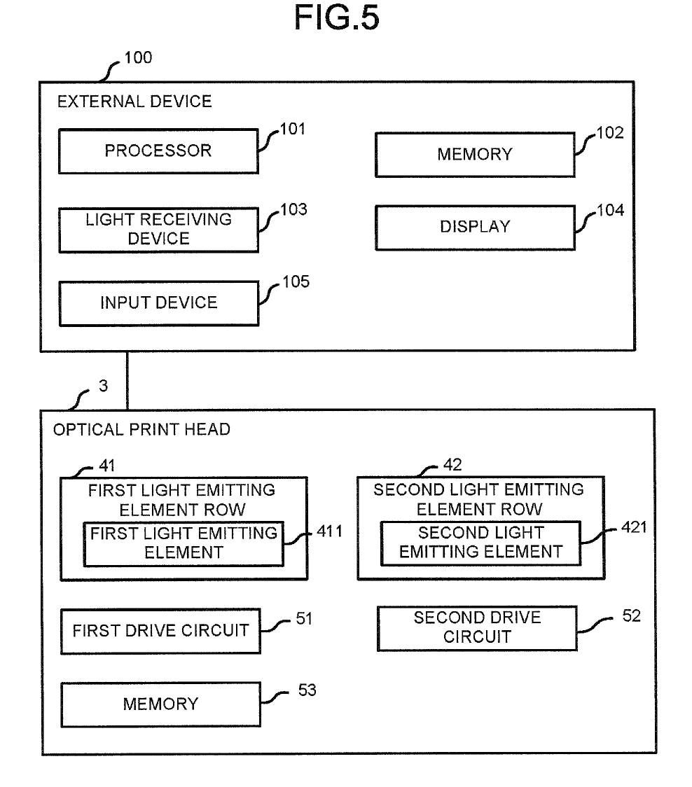

The optical print head 3 is equipped with a first light emitting element row 41, a second light emitting element row 42, a first drive circuit 51, a second drive circuit 52, a memory 53 (refer to FIG. 5) and a microlens array 6.

The light emitting element rows 41 and 42 and the drive circuits 51 and 52 are arranged on a substrate 7 made from glass or resin.

A first light emitting element 411 emits light upwards in FIG. 3 (direction orthogonal to the substrate 7). The first light emitting elements 411 are arranged in a horizontal scanning direction to form the first light emitting element row 41. The horizontal scanning direction refers to a direction in which a beam spot moves along an axial direction of the photoconductive drums 21Y-21K when the first light emitting element row 41 emits light to the photoconductive drums 21Y-21K.

A second light emitting element 421 emits the light towards the upside of FIG. 3.

The substrate 7 is a top emission type substrate on which the light is emitted from upper surfaces of the first light emitting element row 41 and the second light emitting element row 42 simultaneously.

The second light emitting elements 421 are arranged in a row in the horizontal scanning direction to form the second light emitting element row 42. The second light emitting element row 42 is positioned at one side (right side in FIG. 3) of the vertical scanning direction with respect to the first light emitting element row 41. The vertical scanning direction refers to a direction in which the beam spot moves along a circumferential direction of the photoconductive drums 21Y-21K when the second light emitting element row 41 emits the light to the photoconductive drums 21Y-21K.

The light emitting elements 411 and 421 are positioned alternately in the horizontal scanning direction.

The light emitting elements 411 and 421 can be organic electroluminescence elements. The light emitting elements 411 and 421 each at least include an anode which injects an electron hole, a light emitting layer having a light emitting area, and a cathode which injects an electron.

If resolution in the horizontal scanning direction is 1200 dpi, for example, the light emitting elements 411 and 421 are arranged at an interval of 21 μm (=25.4 mm/1200) in the horizontal scanning direction and the numbers thereof are 7680 in total respectively.

In the present embodiment, as there are two rows of the light emitting element rows 41 and 42 in the vertical scanning direction, the resolution can become twice than a case in which there is one row light emitting element row. In the present embodiment, it is possible to increase the areas of the light emitting elements 411 and 421 without changing the resolution in the present embodiment.

The first drive circuit 51 drives the first light emitting element row 41. The first drive circuit 51 can set a current value for the first light emitting element row 41. The first drive circuit 51 can execute the PWM control on the first light emitting element 411 individually through the set current value. The first drive circuit 51 can individually control the light emitting time of the first light emitting element 411. The first drive circuit 51 is positioned at the other side (left side in FIG. 3) of the vertical scanning direction with respect to the first light emitting element row 41. The first drive circuit 51 is positioned at a location nearest to the first light emitting element 411 at the end of one side (front side in FIG. 3) of the horizontal scanning direction among the first light emitting elements 411.

The second drive circuit 52 drives the second light emitting element row 42. The second drive circuit 52 can set a current value for the second light emitting element row 42. The second drive circuit 52 can execute the PWM control on the second light emitting element 421 individually through the set current value. The second drive circuit 52 can control the light emitting time of the second light emitting element 421 individually. The second drive circuit 52 is positioned at one side (right side in FIG. 3) of the vertical scanning direction with respect to the second light emitting element row 42. The second drive circuit 52 is positioned at a location nearest to the second light emitting element 421 at the end of one side (front side in FIG. 3) of the horizontal scanning direction among the second light emitting elements 421.

The drive circuits 51 and 52 are opposite to each other in the vertical scanning direction.

The first drive circuit 51 is positioned at the other side (left side in FIG. 3) of the vertical scanning direction with respect to the first light emitting element row 41. The second drive circuit 52 is positioned at one side (right side in FIG. 3) of the vertical scanning direction with respect to the second light emitting element row 42. Thus, the wiring for connecting the first drive circuit 51 with the first light emitting element 411 and the wiring for connecting the second drive circuit 52 with the second light emitting element 421 are not overlapped.

The rod lens array 6 is equipped with a plurality of integrated columnar rod lenses 611 and 621. The rod lenses 611 are arranged in a row in a scanning direction to form a rod lens row 61. The rod lenses 621 are arranged in a row in the scanning direction to form a rod lens row 62. The rod lens rows 61 and 62 are arranged in the vertical scanning direction in parallel. The rod lens array 6 is positioned at the upper side in FIG. 3 of the light emitting element rows 41 and 42 and opposite to the light emitting element rows 41 and 42. The rod lens array 6 enables the light emitted by each of the light emitting elements 411 and 421 to be imaged on the photoconductive drums 21Y-21K as spot light.

In the present embodiment, the rod lens rows 61 and 62 are arranged corresponding to the first and the second light emitting element rows 41 and 42. However, one rod lens row may be arranged corresponding to a plurality of (e.g., 2) light emitting element rows.

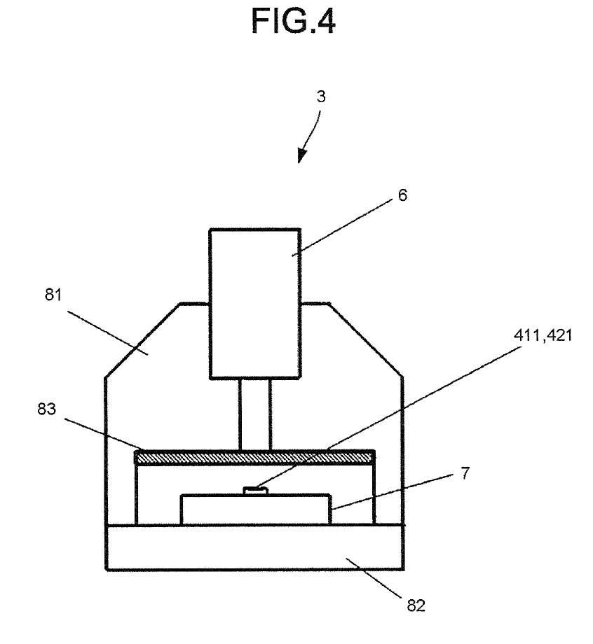

FIG. 4 is a cross-sectional diagram illustrating the optical print head 3.

A lid 82 blocks the internal space of a holder 81. The lid 82 holds the substrate 7. The light emitting elements 411 and 421 on the substrate 7 are sealed by a sealing glass 83. The holder 81 positions the rod lens array 6 and positions the substrate 7 at an operating distance of the rod lens array 6.

FIG. 5 is a block diagram illustrating components of an external device 100.

In the manufacturing line of the image forming apparatus 1, the external device 100 is connected with the optical print head 3. The external device 100 is equipped with a processor 101, a memory 102, a light receiving device 103, a display 104 and an input device 105. The processor 101 acting as a CPU executes programs stored in the memory 102 to execute various processing of the external device 100. The light receiving device 103 measures the amounts of light of the light emitted by the light emitting elements 411 and 421 through the rod lens array 6. The display 104 displays setting information or operation status of the external device 100, log information and notification to the user. The input device 105 including a touch panel or buttons receives input of the user.

The external device 100 executes the following light amount correction processing.

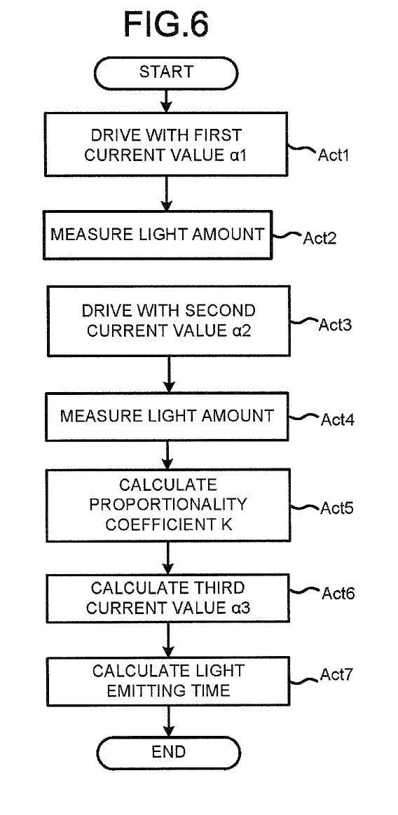

FIG. 6 is a flowchart illustrating the light amount correction method.

The external device 100 drives the light emitting element rows 41 and 42 with a first current value α1 at a first light emitting time T1 simultaneously with the drive circuits 51 and 52 (ACT 1).

The external device 100 measures a first light amount L1 of the light emitted by each first light emitting element 411 of the first light emitting element row 41 passing through the rod lens array 6. The external device 100 measures a second light amount L2 of the light emitted by each second light emitting element 421 of the second light emitting element row 42 passing through the rod lens array 6 (ACT 2).

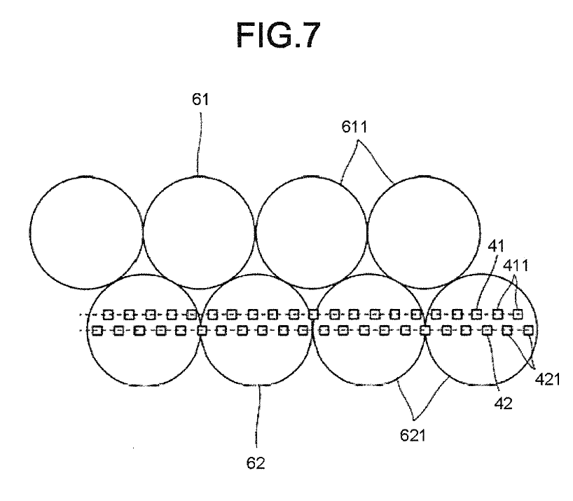

FIG. 7 is a diagram illustrating a positional relation between the light emitting element rows 41 and 42 and the rod lenses 611 and 621.

The diameter of each of the rod lenses 611 and 621 can be the same or different, but in this case, for example, is 900 μm. The light emitting surface of each of the light emitting elements 411 and 421 is a rectangular shape and dimension of two sides (length and width) of the light emitting surface is 30 μm*30 μm, for example. The interval of the adjacent central parts of the light emitting element rows 41 and 42 in the vertical scanning direction (up and down direction of FIG. 7) is 105 μm for example. Other dimensions for the aforementioned elements are possible.

With respect to the diameter of each of the rod lenses 611 and 621, the diameter of each of the light emitting elements 411 and 421 is very small and the interval of the light emitting element rows 41 and 42 is also very small. Thus, if the incorporation position of each component is deviated from the ideal position, a case in which the positions of the light emitting element rows 41 and 42 are biased towards one of the rod lens rows 61 and 62 occurs. In the present embodiment, the second light emitting element row 42 passes through the central part of the rod lens 621 and the first light emitting element row 41 passes through a position away from the central part of the rod lens 621 with respect to the second light emitting element row 42.

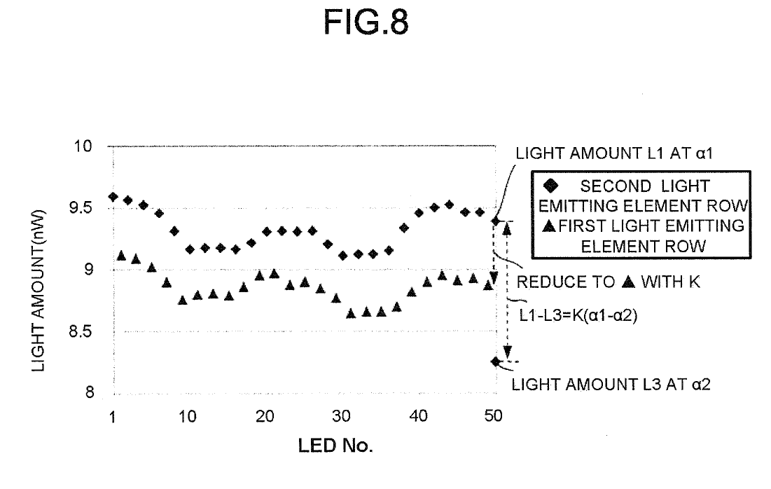

FIG. 8 is a diagram illustrating a measurement result of the light amount and L1 and the light amount L2 of the light emitting elements 411 and 421.

Through the difference in the position with respect to the rod lens row 62, a difference occurs in the light transmittance of the first light emitting element row 41 and the second light emitting element row 42 with respect to the rod lens rows 61 and 62. Thus, the light amount of the second light emitting element 421 of the second light emitting element row 42 is 10% on an average more than that of the first light emitting element 411 of the first light emitting element row 41. Thus, in the conventional light amount correction, dispersion of the light of each of the light emitting elements 41 and 42 cannot be completely suppressed, which causes image degradation. Thus, the external device 100 executes the processing in ACT 1-ACT 6 before the conventional light amount correction.

The external device 100 drives the second light emitting element row 42 with a second current value α2 smaller than the first current value α at the first light emitting time T1 (ACT 3). The second current value α2 is set to a value so that a third light amount L3 of the second light emitting element 421 at the time of applying a current with the second current value α2 is smaller than the first light amount L1 of the first light emitting element 411 corresponding to the second light emitting element 421. Hereinafter, the first light emitting element 411 corresponding to the second light emitting element 421 refers to the first light emitting element 411 corresponding to the second light emitting element 421 in the vertical scanning direction. Further, the first light emitting element 411 corresponding to the second light emitting element 421 refers to the first light emitting element 411 having the same number as the second light emitting element 421 when the first and the second light emitting elements 411 and 421 of the first and the second light emitting element rows 41 and 42 are numbered from one side of the scanning direction.

The external device 100 measures the third light amount L3 of each second light emitting element 421 of the second light emitting element row 42 (ACT 4).

The relation between the current value and the light amount is a proportional relation. For example, in FIG. 7, the difference (L1−L3) of the amounts of light of the second light emitting element 421 at the time of being driven with the first and the second current values α1 and α2 different from each other is obtained by multiplying a proportionality coefficient K by the difference (α1−α2) of the current values and is indicated by the following formula (1).

L1−L3=K(α1−α2) (1)

The external device 100 calculates the proportionality coefficient K based on the formula (1) (ACT 5).

The external device 100 calculates a third current value α3 of a certain second light emitting element 421 based on the following formula (2) when the light amount at the time of driving the second light emitting element 421 at the first light emitting time T1 is equal to the first light amount L1 at the time of driving the first light emitting element 411 corresponding to the second light emitting element 421 with the first current value α1 at the first light emitting time T1 (ACT 6).

L1−L2=K(α1−α3) (2)

The external device 100 calculates a second light emitting time T2 at which a target light amount (reference light amount) is obtained for each first light emitting element 411 at the time of executing the PWM control by taking the current value of the first light emitting element 411 as the first current value α1.

The external device 100 calculates a third light emitting time T3 at which a target light amount is obtained for each second light emitting element 421 at the time of executing the PWM control by taking the current value of the second light emitting element 421 as the third current value α3.

The external device 100 writes the correction information such as the first and the third current values α1 and α3 and the second light emitting time T2 and the third light emitting time T3 into the built-in memory 53 (FIG. 5) of the optical print head 3 (ACT 7).

In the present embodiment, as the drive circuits 51 and 52 are arranged for each of the first and the second light emitting element rows 41 and 42, the first and the second light emitting element rows 41 and 42 can be driven with different current values and the dispersion of the amounts of light of the light emitting element rows 41 and 42 can be suppressed.

If the optical print head 3 is incorporated in the apparatus and receives an instruction for driving the first and the second light emitting elements 411 and 421, the first and the second drive circuits 51 and 52 drives the first and the second light emitting elements 411 and 421 according to the correction information.

In this case, the first drive circuit 51 drives each first light emitting element 411 with the same first driving current value (e.g., the first current value α1) and drives each first light emitting element 411 at the light emitting time corresponding to each target gradation value respectively.

The second drive circuit 52 drives, in response to the transmittance of the light passing position of the rod lens array 6, each second light emitting element 421 with the same second driving current value (e.g., the third current value α3) and drives each second light emitting element 421 at the light emitting time corresponding to each target gradation value respectively.

The number of the first drive circuit 51 for driving the first light emitting element row 41 is not limited to one. The first light emitting elements 411 may be classified into several groups and a plurality of the first drive circuits 51 may be set respectively corresponding to the groups. The second drive circuit 52 is the same as the first drive circuit 51.

The first and the second light emitting element rows 41 and 42 may not have 2 rows in total. In this case, the foregoing processing is executed between the first light emitting element row 41 of each other row and the second light emitting element row 42 of each other row.

The drive circuits 51 and 52 may be arranged at positions sandwiching the first and the second light emitting element rows 41 and 42 in the vertical scanning direction.

The external device 100, if the light amount of the first light emitting element row 41 is greater than that of the second light emitting element row 42, lowers the current value of the first light emitting element row 41 and measures the light amount thereof to calculate the proportionality coefficient K of the first light emitting element 411. Then, the external device 100, at the time of driving the first light emitting element 411 at the first light emitting time T1, calculates the current value when the light amount is equal to the second light amount L2 of the second light emitting element.

The second current value α2 at the time of calculating the proportionality coefficient K may be greater than the first current value α1. However, if a possibility that the light amount is not increased even if the current value is increased is taken into consideration, the second current value α2 is preferably lower than the first current value α1.

As described above in detail, according to the technology described in the specification, a technology for suppressing the dispersion of the light from the optical print head can be supplied.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An optical print head comprising:
a first light emitting element row configured to include first light emitting elements arranged in a row in a first direction;
a second light emitting element row configured to include second light emitting elements arranged in a row in the first direction and be positioned at one side of a second direction orthogonal to the first direction with respect to the first light emitting element row;
a rod lens array through which light emitted by the first light emitting element and the second light emitting element passes;
a first drive circuit configured to drive each first light emitting element with identical first current value and drive each first light emitting element at a light emitting time corresponding to each target gradation value; and
a second drive circuit configured to, in response to transmittance of a light passing position of the rod lens array, drive each second light emitting element with identical second current value and drive each second light emitting element at a light emitting time corresponding to each target gradation value, wherein the second current value is different from the first current value.

2. The optical print head according to claim 1, wherein
the first drive circuit is positioned at the other side of the second direction with respect to the first light emitting element row, and the second drive circuit is positioned at the one side of the second direction with respect to the second light emitting element row.

3. The optical print head according to claim 1, further comprising
a memory configured to store a third current value and a fourth current value when the amounts of light of the first light emitting element and the second light emitting element are the same at the time of driving the first light emitting element with the third current value and driving the second light emitting element with the fourth current value at the same light emitting time simultaneously, a light emitting time of the first light emitting element when light amount of each first light emitting element reaches a reference light amount at the time of driving each first light emitting element with the third current value and a light emitting time of the second light emitting element when light amount of each second light emitting element reaches a reference light amount at the time of driving each second light emitting element with the fourth current value, wherein
the first drive circuit executes a Pulse Width Modulation control on the first light emitting element, and the second drive circuit executes the Pulse Width Modulation control on the second light emitting element.

4. The optical print head according to claim 2, wherein
the first drive circuit is positioned at a location nearest to the first light emitting element located at the end of one side of the first direction among the first light emitting elements; and
the second drive circuit is positioned at a location nearest to the second light emitting element located at the end of the one side of the first direction among the second light emitting element.

5. The optical print head according to claim 1, wherein
the first light emitting element and the second light emitting element are positioned alternately in the first direction.

6. The optical print head according to claim 1, wherein
the first light emitting element and the second light emitting element are organic electroluminescence elements.

7. An image forming apparatus, comprising:
a photoconductor;
an optical print head according to claim 1 configured to expose the photoconductor to form an electrostatic latent image on the photoconductor; and
a developing device configured to develop the electrostatic latent image to form a toner image on the photoconductor.

8. A light amount correction method of an optical print head, comprising:
driving a first light emitting element with a first current value at a first light emitting time and measuring a first light amount of light emitted by the first light emitting element through a rod lens array;
driving a second light emitting element with the first current value at the first light emitting time and measuring a second light amount of light emitted by the second light emitting element through the rod lens array; and
driving the first light emitting element with a second current value different from the first current value at the first light emitting time and measuring a third light amount of the light emitted by the first light emitting element through the rod lens array to calculate the second current value of the current through which the light amount of the first light emitting element becomes the second light amount when the first light emitting element is driven at the first light emitting time, or driving the second light emitting element with a third current value different from the first current value at the first light emitting time and measuring a fourth light amount of the light emitted by the second light emitting element through the rod lens array to calculate a fourth current value of the current through which the light amount of the second light emitting element becomes the first light amount when the second light emitting element is driven at the first light emitting time.

9. The method according to claim 8, wherein
if the first light amount is greater than the second light amount, calculating the second current value, and if the second light amount is greater than the first light amount, calculating the fourth current value.

10. The method according to claim 9, wherein
the optical print head is equipped with a first drive circuit configured to drive the first light emitting element row and a second drive circuit configured to drive the second light emitting element row.
